(19) United States
(12) Patent Application Publication
(10) Pub. No.: US 2013/0002373 A1
(43) Pub. Date: Jan. 3, 2013

(54) HIGH REJECTION BAND-STOP FILTER AND DIPLEXER USING SUCH FILTERS

(76) Inventors: Jean-Luc Robert, Betton (FR); Dominique Lo Hine Tong, Rennes (FR); Ali Louzir, Rennes (FR); Philippe Minard, Saint Medard Sur Ille (FR); Jean-Yves Le Naour, Pace (FR)

(21) Appl. No.: 13/529,627

(22) Filed: Jun. 21, 2012

(30) Foreign Application Priority Data
Jun. 29, 2011 (FR) 1155819

(51) Int. Cl. H01P 1/203

(52) U.S. Cl. 333/204

(57) ABSTRACT

The present invention relates to a high rejection stop band filter and a diplexer using such filters.

The stop band filter comprises on a substrate with a ground plane, a transmission line extending between an input and an output and comprises several resonators formed of “stubs” in printed open circuit embedded into the transmission line, the resonators being positioned in parallel together and interconnected in series in the same direction or head to tail.

The filters are particularly useful in mobile devices operating in two concurrent frequency bands.

The present invention relates to a high rejection band-stop filter, more specifically it relates to a band-stop filter in printed technology. The present invention also relates to diplexers using such filters.

### BACKGROUND OF THE INVENTION

In the scope of high bitrate multimedia networks in a domestic environment, there is a growing demand to be able to have digital contents on the various available multimedia devices such as television sets, computers, games consoles, tablets or smart-phones. Hence, it appears necessary to have on these devices a concurrent dual frequency band wireless access that enables data and multimedia applications to be carried simultaneously.

Currently, some products offer concurrent wireless access (WiFi) in the 2.4 GHz and 5 GHz frequency bands. In this case, the 2.4 GHz frequency band is assigned to the transfer of standard data or video while the 5 GHz frequency band is assigned to the transfer of high-definition streams or high resolution games.

However, the 2.4 GHz WiFi band only has three adjacent channels while the 5 GHz WiFi band has 24 channels. A WiFi access point ensuring concurrent functioning in two contiguous 5 GHz frequency bands enables the distribution of contents in future domestic networks to be noticeably improved and limits potential interference problems. However, the challenge consisting in sharing a single system of antennas with two concurrent radio circuits in the same frequency band, namely the 5 GHz frequency band, resides in the isolation capacity between two active circuits, this challenge being all the more significant as the two frequency bands are practically contiguous.

In this case, very high rejection exterior filters are required to ensure sufficient isolation for correct concurrent functioning. However, currently no filtering device exists operating in the 5 GHz frequency band that enables isolation in the order of 40 dB to be obtained. Analysis carried out on active filters has demonstrated limitations due primarily to their linearity. Topologies of low-pass/high-pass type with mixed structure, passive elements and microstrip, have been simulated. The simulations show that a high number of poles are required to ensure the required performances, which results in complex filters.

In order to limit the number of poles, there was an effort to produce a symmetrical response stop band type filters for each of the two 5 GHz WiFi bands either the band 5.15-5.35 GHz for the low band or the band 5.45-5.72 GHz for the high band, the challenge being to ensure a rejection of 40 dB in the 120 MHz separating these two bands

To produce asymmetrical response stop band filters responding to the criteria above, work was based on the studies made by Hussein Nasser Hamad Shaman in his thesis of August 2008 entitled “Advanced ultra wideband (UWB) microwave filters for modern wireless communication” at Heriot-Watt University. In this thesis describing different types of ultra wideband microwave filters, Shaman compared performances relating to the bandwidth of diverse structures formed from a transmission line and a “stub”. Thus as shown in FIG. 1, Shaman compares the performances of:

A) A conventional stub in open circuit, namely a transmission line 1 with an input terminal referenced as “input” and an output terminal referenced as “output”, a stub 2 of length λ/4 where λ corresponds to the operating frequency, the transmission line having a width Wc while the stub has a weaker width, Ws,

B) a “SPUR-LINE” pattern, as shown in FIG. 1, a transmission stub 3 comprising an input point “Input” and an output point “Output”, this line being fitted with a slot 4 cutting a stub 3a of length λ/4, the slot having a width G, the stub 3a a width Ws and the transmission line 3′ a width Wc,

C) A stub in open circuit inserted into a microstrip line called an “embedded open circuited stub”, this stub being produced, as shown in FIG. 1, via a transmission line 5 with an input “input” and an output “output” in which is realised a stub 6 obtained by etching in U form the transmission line 5 in such a way to form a stub 6 having a length λ/4 where λ is the wavelength at the operating frequency and a width Ws while the transmission line has a width We and the U etching forming a slot of width G.

The simulation of three embodiments A, B, C provided the reflection curve S11 and the transmission curve S21 shown on the right of the FIG. 1. As these curves show, it can be seen that a greater rejection can be obtained with the embodiment C, namely the stub in open circuit.

Complementary studies were carried out forming a stop band filter using two resonators as shown by C in FIG. 1. According to a standard topology, two resonators were mounted in series in the same direction, as shown in FIG. 2 or in series head to tail as shown in FIG. 3. More specifically, the band-stop filter constituted of two resonators in series in the same direction shown in FIG. 2, were realised as follows: on a substrate 10 with a conductive layer, were implemented a first resonator 11a and a second resonator 11b mounted in series in the same direction, the two resonators 11a and 11b being interconnected via a coupling line 12. These resonators can be symbolised by the elements R1 and the coupling line by the element Phi representing the coupling phase between resonators. Likewise, in FIG. 3, a band-stop filter is shown formed of two resonators in series head to tail. Thus, on a substrate 20 equipped with a conductive layer was produced a first resonator 21a interconnected via a coupling line 22 to a second resonator 21b mounted head to tail with respect to the resonator 21a. The two embodiments of FIGS. 2 and 3 were simulated providing, for the coupling line 12 or 22, different lengths that enable the inter-resonator coupling phase to be modified. The curves shown in FIGS. 2 and 3 shows that the inter-resonator phase coupling modification induce a displacement of reflection zeros without modification of the response in transmission. This specific non-reciprocal behaviour of the coupling can be used to increase the steepness of the stop band filter either on the right or on the left, according to the 5 GHz frequency band to be rejected.

It can be seen that the adjustment in the length of inter-resonator coupling is the same as shifting one of the reflection zeros close to the desired cut-off frequency and that an inverse behaviour is obtained depending on whether the resonators in series are in the same direction, as in FIG. 2, or head to tail, as in FIG. 3. This interesting property is thus exploited to design asymmetric response stop band filters for which will be used a filter formed of resonators in series in the same direction or a filter formed of filters in series head to tail, according to selectivity on the left or right flank.

However, the implementation of several resonators as described in FIGS. 2 and 3 does not enable easily used stop band filters to be obtained. The filters obtained have a significant size, as each resonator is locked on λ/4.

### SUMMARY OF THE INVENTION

Consequently, the present invention proposes a new stop band filter structure using resonators constituted of stubs in open circuit inserted in a transmission line, specifically a microstrip line, that has both a significant rejection in the operating frequency band, namely 5 GHz in a particular embodiment, and that is also compact.

The purpose of the present invention is thus an asymmetrical response stop band filter comprising, a substrate with a ground plane, an etched transmission line extending between an input terminal and an output terminal and at least two resonators, each resonator being constituted by a section of printed line or “stub” in open circuit, embedded into the printed transmission line, characterized in that the at least two resonators are positioned in parallel together, on the substrate and interconnected in series in the same direction or head to tail. The parallel position of the resonators enables a compact filter to be obtained. Contrary to standard microstrip type topologies, this structure has a co-planar propagation mode and as a result, no coupling appears between the various resonators, the field remaining concentrated between the stub and the associated slots.

According to another characteristic of the present invention, the number of resonators constituting the filter is calculated according to the level of rejection required. Moreover, the length of the transmission line interconnecting two resonators, corresponds to a coupling length less than 20° at the frequency considered for a connection in series in the same direction and at 90° for a connection in series head to tail.

In addition, to enable the surface of the substrate to be further reduced, the substrate is a low loss substrate such as the substrate known as Arlon 25N. The substrate used can also be a standard hyper-frequency substrate such as the substrate called RO4003 by Rogers.

The present invention also relates to a diplexer enabling operation in the adjacent frequency bands, characterized in that it comprises two asymmetrical response stop band filters as described above, the two filters being interconnected via an interconnection line ensuring their reciprocal isolation, one of the filters operating in the high band and the other filter operating in the low band of the band of operating frequencies.

Preferably, the filter operating in the high band comprises resonators interconnected in series head to tail and the filter operating in the low band comprises resonators interconnected in series in the same direction.

### BRIEF DESCRIPTION OF THE DRAWINGS

Other characteristics and advantages of the invention will appear upon reading the description of different embodiments, this description being realized with reference to the enclosed drawings, wherein:

FIG. 1, already described diagrammatically represents different embodiments of resonators as well as their transmission and reflection curves, according to the frequency.

FIG. 2, already described, shows a first embodiment of a stop band filter comprising two open circuit “stub” type resonators, mounted in series in direct direction as well as the transmission curves for different lengths of the coupling line providing the phase.

FIG. 3, already described, shows another embodiment of a stop band filter formed of two open circuit “stub” type resonators, mounted in series head to tail as well as the transmission curves for different lengths of the coupling line between the two resonators.

FIG. 4 shows a first embodiment of a high rejection stop band filter in accordance with the present invention as well as the reflection and transmission curves of said filter.

FIG. 5 shows a second embodiment of a high rejection stop band filter in accordance with the present invention as well as the reflection and transmission curves of said filter.

FIG. 6 shows, for the embodiment of FIG. 5, the reflection and transmission curves according to the number of resonators constituting the stop band filter.

FIG. 7 shows an embodiment of a diplexer constituted by two stop band filters according to the embodiments of FIG. 4 and FIG. 5 as well as their reflection and transmission curves.

FIG. 8 shows the measured responses of a particular embodiment of stop band filters in (a) and of the diplexer in (b).

### DETAILED DESCRIPTION OF THE EMBODIMENTS

In FIG. 4, a first embodiment is shown of a high rejection stop band filter in accordance with the present invention. The left side of FIG. 4 diagrammatically shows the structure of the filter while the right side of FIG. 4 provides the transmission and reflection curves simulated for said filter.

As shown in the left side, on a substrate 30 with a conductive layer, four resonators 31a, 31b, 31c and 31d were realised mounted in parallel together in cascade. Each resonator 31a, 31b, 31c and 31d is formed by a stub of length λ/4 etched in a transmission line, as described for the embodiment C of FIG. 1.

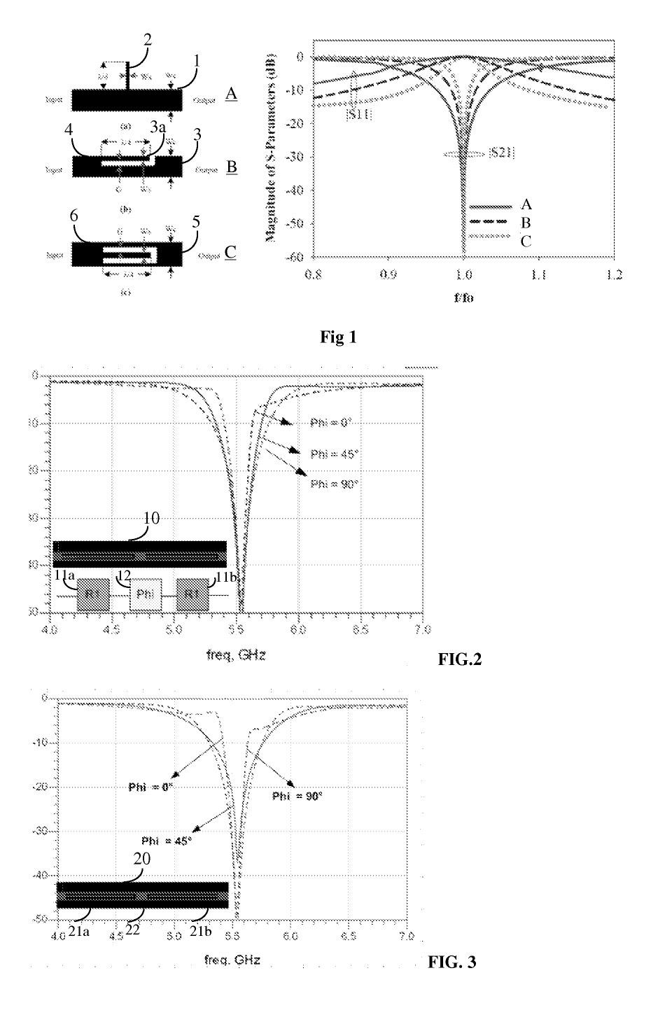

In the embodiment of FIG. 4, the resonator 31a is connected to the resonator 31b in series in the same direction by a coupling stub 32a whose length determines the coupling phase. Likewise, the resonator 31b is connected to the resonator 31c in series in the same direction, by a coupling line 32b and the resonator 31c is connected to the resonator 31d by a coupling line 32c. The length of the coupling line 32a, 32b, 32c is selected to be as low as possible, which enables the steepness of the filter to be accentuated at the transition of two WiFi bands, as explained with reference to FIG. 2. The filter input is realised at the level of port 1 and the output of the filter is realised at the level of port 2. The electromagnetic simulation of the filter of FIG. 4 is shown on the right side of FIG. 4. The filter of FIG. 4 is particularly adapted to operate in the low band, namely in the embodiment shown, the frequencies band comprised between 5.15-5.35 GHz. It has a more steep edge on the right side of the transmission curve. Thus, this filter type will be used rather as a low band filter.

A description will now be given, with reference to FIG. 5, of another embodiment of a high rejection stop band filter in accordance with the present invention. In this figure, as in FIG. 4, the left side diagrammatically shows the filter structure while the right side shows the simulated transmission and reflection curves of said filter.

As shown on the left side, four resonators 41a, 41b, 41c and 41d, were realised in cascade on a substrate 40 with a conductive layer. In this embodiment, the four resonators are mounted in series head to tail. Each resonator 41a, 41b, 41c, 41d is formed, likewise the embodiment of FIG. 4, of a stub of length λ/4 etched in a transmission line. As shown in the figure, two resonators 41a, 41b are interconnected head to tail via a coupling line 42a for which the length determines the coupling phase. Likewise, the resonator 41b is interconnected to the resonator 41c via a coupling line 42b and the resonator 41c is interconnected to the resonator 41d via a coupling line 42c. The filter input is realised at the level of the port 1 and the filter output is realised at the level of the port 2. The simulations carried out on the filter of FIG. 5 provide the reflection and transmission curves shown in the right side of FIG. 5. In this case, an abrupt edge is observed on the left side of transmission curves and transmission zeros between 5.470 and 5.720 GHz. This filter structure is used mainly as a stop band filter for the high band of the 5 GHz frequency band.

As shown on the curve of FIG. 5, it can be seen that in the case of a filter comprising four resonators mounted in series head to tail, a level of rejection in or around −20 dB is obtained. This level of rejection is in general insufficient to ensure the isolation performance levels required, in the case where this filter is used to isolate two contiguous frequency bands.

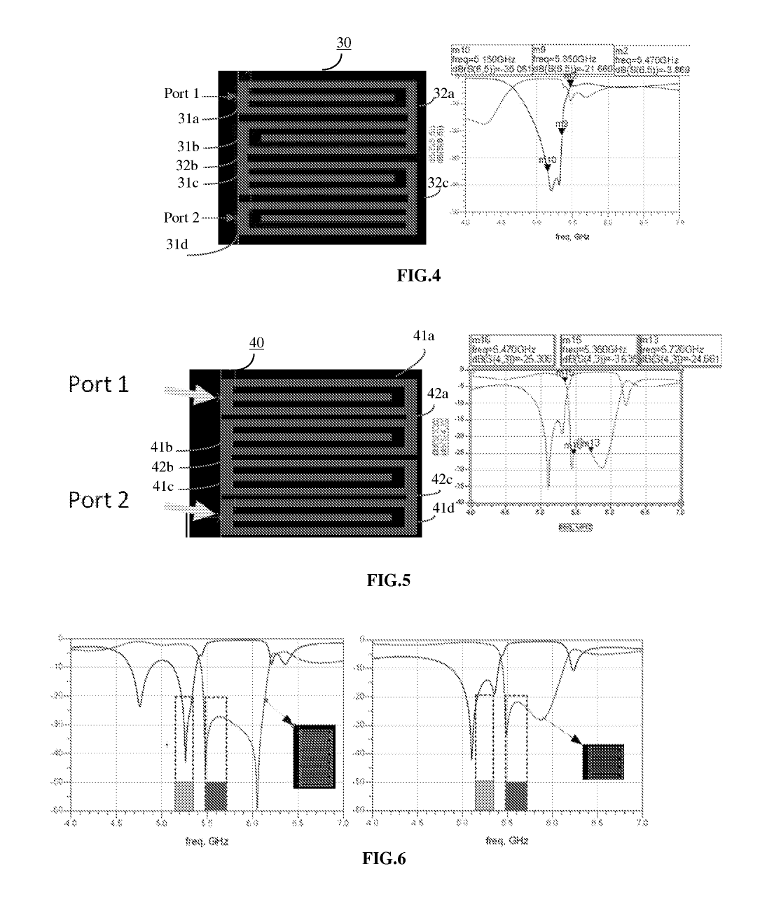

As a result, as shown in FIG. 6, the performance levels of a high rejection stop band filter formed of resonators in series head to tail, were simulated modifying the number of resonators in a way to study the transmission responses of the filters.

As shown on the left side of FIG. 6, a stop band filter was simulated comprising six resonators mounted head to tail while on the right side, transmission and reflection curves are shown of stop band filters with four resonators mounted head to tail as in FIG. 5. The curves obtained show that a greater rejection level is obtained with a stop band filter comprising six resonators mounted in series head to tail.

The results obtained above are used to produce a diplexer enabling a same antenna system to be shared in concurrent dual radio [symbol] architecture

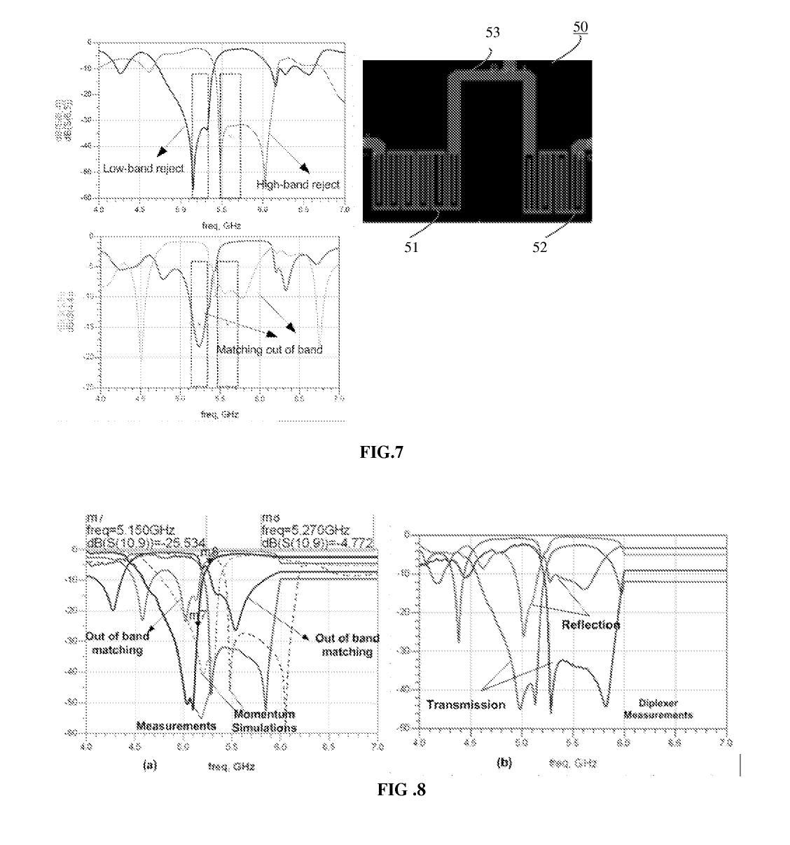

As shown in the right side of FIG. 7, the diplexer is constituted on a substrate 50 with a conductive layer, of a first filter 51 formed of six resonators in series head to tail enabling a high band filter to be obtained. This resonator 51 is connected via a microstrip line 53 to a band-stop filter 52 formed of four resonators in series in direct direction providing a low band filter, the microstrip line interconnecting the resonators 51 and 52 enabling a reciprocal isolation to be ensured between the two stop band filters.

The diplexer of FIG. 7 was simulated and the transmission response of the two filters is provided by the curves on top of FIG. 7 while the reflection response of the two filters is provided by the curves at the bottom of FIG. 7. It can be seen that a low band rejection is thus obtained at around 5.15 GHz and a high band rejection in the range 5.5-5.7 GHz is obtained with a level of rejection comprised between −30 and −40 dB. It is noted that the bandwidth of the rejected band in low band is narrower than in the high band. This phenomenon is linked to the structural differences of the resonators, namely in the same direction or head to tail, inducing different couplings. The second graph describes the adaptation in the bandwidth of rejection filters, in the order of 10 dB for the low band filter and greater than 15 dB for the high band filter.

To complete the study, a printed circuit was produced using as a substrate, the substrate called 25N from the Arlon company with εr=3.38, a TgD=0.0027. In order to limit conductivity losses, the nickel-gold type surface treatment was left out. Stop band filters such as described in FIGS. 4 and 5 were produced on this substrate as well as a diplexer as described in FIG. 7. The measurements of transmission and reflection were thus realised with these different circuits and the measurement results are shown in FIG. 8 in part (a) for the filters and in part (b) for the diplexer. For the diplexer, a rejection is thus observed for a low band between 5 and 5.2 GHz and a rejection for a high band between 5.3 and 5.8 GHz with a rejection level greater than −30 dB. FIG. 8a describes for each band-stop filter, the comparative results obtained by measurement and by electromagnetic simulation, FIG. 8b describes the reflection and transmission responses of 2 channels of the diplexer.

The embodiments described above were provided as examples. It will be evident to those skilled in the art that they can be modified, particularly concerning the number of resonators, the materials used for the substrate or the transmission lines, the operating frequency bands, etc.

What is claimed is:

1. Asymmetric response stop band filter comprising on a substrate with a ground plane, a transmission line extending between an input terminal and an output terminal and at least two resonators, each resonator being constituted by a section of printed line or “stub” in open circuit, embedded into the printed transmission line, wherein the at least two resonators are positioned in parallel together, on the substrate and interconnected in series in the same direction or head to tail.

2. Stop band filter according to claim 1, wherein the number of resonators constituting the filter is calculated according to the level of rejection required.

3. Stop band filter according to claim 1, wherein the transmission line interconnecting two resonators has a length corresponding to a coupling length of <20 ° for a connection in series in the same direction and at 90° for a connection in series head to tail.

4. Stop band filter according to claim 1, wherein the transmission line interconnecting two resonators has a length corresponding to a coupling length of 90° for a connection in series head to tail.

5. Stop band filter according to claim 1, wherein the substrate is a low loss substrate such as the substrate known as ARLON 25 N.

6. Diplexer enabling operation in adjacent frequency bands of an operating frequency, comprising two asymmetric response stop band filters, each filter comprising on a substrate with a ground plane, a transmission line extending between an input terminal and an output terminal and at least two resonators, each resonator being constituted by a section of printed line or “stub” in open circuit, embedded into the printed transmission line, wherein the at least two resonators are positioned in parallel together, on the substrate and interconnected in series in the same direction or head to tail, the two filters being mounted in series, one of the filters operating in a high band frequency of the operating frequency and the other filter operating in a low band frequency of the operating frequency.

7. Diplexer according to claim 6, wherein the filter operating in the high band comprises six resonators interconnected in series head to tail and the filter operating in the low band comprises four resonators interconnected in series in the same direction.
